(19) United States
(12) Patent Application Publication
(10) Pub. No.: US 2012/0235556 A1
(43) Pub. Date: Sep. 20, 2012

(54) SAFETY LAMP

(75) Inventor: Yu-Chi Wu, Taipei (TW)

(73) Assignee: ADVANCED CONNECTEK INC., Taipei (TW)

(21) Appl. No.: 13/106,192

(22) Filed: May 12, 2011

(30) Foreign Application Priority Data
Mar. 14, 2011 (TW) 100108505

(51) Int. Cl. H01J 1/62; H01J 5/00

(52) U.S. Cl. 313/483; 313/323

(57) ABSTRACT

A safety lamp, which comprises a lamp body and two electric connecting portions. The lamp body has a light emitting module. The two electric connecting portions are respectively disposed on two sides of the lamp body, and each of the electric connecting portions further comprises a first electric connecting terminal, a pressing switch unit, an elastic conductive unit and a second electric connecting terminal. Each of the pressing switch units must sustain a pressing force to urge against the corresponding elastic conductive unit to deform and to electrically connect the corresponding first electric connecting terminal to the corresponding second electric connecting terminal through the elastic conductive unit. Alternatively, when the pressing switch unit is released from the pressing force, the deformed elastic conductive unit reforms back to an opposite direction of the pressing force to form an open circuit.

### FIELD OF THE INVENTION

The present invention relates to a safety lamp, and particularly to a safety lamp having a pressing switch unit for a user to install the safety lamp without being exposed to danger of electric shock.

### BACKGROUND

Conventional fluorescent lamps are known for their advantages to have wide light emission areas, but also have major drawbacks such as high power consumption and short life spans. In recent years, with improvement of light emission technology, lamps such as light emitting diodes (LEDs), organic light emitting diodes (OLEDs), and electroluminescent (EL) lamps are introduced. These new lamps have longer life spans and lower power consumption and generate less heat. However, to fit in the lamp holders of the current lamps, the new lamps are designed to have a plurality of electrode pins on their sides such that the electrode pins can be electrically connected to the power slots of the lamp holders to provide electricity power to the lamps.

However, when a user installs or removes a lamp, and the electrode pins on one side of the lamp is electrically connected to the power slots, it is possible that the user would touch the electrode pins exposed on the other side of the lamp to form a closed circuit, as shown in FIG. 1, thus creating danger of electric shock for the user in installing or removing the lamp.

Therefore, there is a need to provide a lamp with a safety switch to ensure the safety of the user in installing or removing the lamp.

### SUMMARY OF THE INVENTION

An objective of the present invention is to provide a safety lamp to achieve safety in installing and removing the lamp without requiring the consumers to change the accustomed procedures of installing and removing the lamp.

Another objective of the present invention is to provide a safety lamp that can be used safely without changing the design of the current lamp holders.

A further objective of the present invention is to provide a safety lamp in which safety can be highly achieved by a simple elastic switch mechanism with low cost.

Another objective of the present invention is to provide a safety lamp, which has two pressing switch units on both sides, and the safety lamp is electrically connected to the lamp holder only when both pressing switch units are pressed. Therefore, when a user installs or removes the safety lamp and one side of the safety lamp is electrically connected to the lamp holder, the pressing switch unit on the other side of the safety lamp is free from pressing and an open circuit is formed, so the user is free from being exposed to the danger of electric shock by touching the electrode pins on the side where the pressing switch unit is free from pressing, and the high safety is thus achieved.

To achieve the foregoing objectives of the invention, the invention provides a safety lamp, which suited to be installed to a lamp holder. The safety lamp comprises a lamp body and two electric connecting portions. The lamp body has a light emitting module. The two electric connecting portions are respectively disposed on two sides of the lamp body, and each of the electric connecting portions further comprises a first electric connecting terminal, a pressing switch unit, an elastic conductive unit and a second electric connecting terminal. The first electric connecting terminal is partly disposed in the electric connecting portion and partly protruding from the electric connecting portion for being electrically connected to a power slot of the lamp holder. The pressing switch unit is partly disposed in the electric connecting portion and partly protruding from the electric connecting portion. The elastic conductive unit is electrically connected to the first electric connecting terminal. The second electric connecting terminal is electrically connected to the light emitting module. When the pressing switch unit of each of the two electric connecting portions is free from pressing, the corresponding elastic conductive unit is not electrically connected to the corresponding second electric connecting terminal to form an open circuit between the first electric connecting terminal and the second electric connecting terminal. Furthermore, when each of the two electric connecting portions is installed to the lamp holder and the corresponding pressing switch unit is in contact to the lamp holder to sustain a pressing force, the pressing switch unit urges against the corresponding elastic conductive unit to electrically connect the elastic conductive unit to the corresponding second electric connecting terminal and to form a conductive status between the first electric connecting terminal and the second electric connecting terminal. When the pressing switch unit is released from the pressing force, the deformed elastic conductive unit reforms back to an opposite direction of the pressing force to push the pressing switch unit back, thus forming an open circuit between the first electric connecting terminal and the second electric connecting terminal.

Comparing to the conventional technology, the safety lamp of the present invention is provided to be electrically connected via the elastic conductive unit by selection of the pressing switch unit when a user to install the safety lamp, thus avoiding the possibility that the user is exposed to the electric shock in installing the lamp to the lamp holder and achieving high safety of lamp installment. When the safety lamp is installed to the lamp holder, both pressing switch units of the two electric connecting portions on the two side of the safety lamp must be installed and pressed in the lamp holder to form a closed circuit between the safety lamp and the lamp holder.

### BRIEF DESCRIPTION OF THE DRAWINGS

FIG. 1 is a schematic view of a circuit of the conventional lamp;

FIG. 2 is a schematic view of an embodiment of a safety lamp of the present invention;

FIG. 3 is a schematic view of another embodiment of a safety lamp of the present invention;

FIG. 4 is a schematic view showing structure and operation of the electric connecting portion in FIG. 3;

FIG. 5 is a schematic view of a lamp holder;

FIG. 6 and FIG. 7 are schematic views of an embodiment of the safety lamp of the present invention and the lamp holder before and after being assembled; and

FIG. 8 is a schematic view showing different operation of the electric connecting portion in FIG. 3.

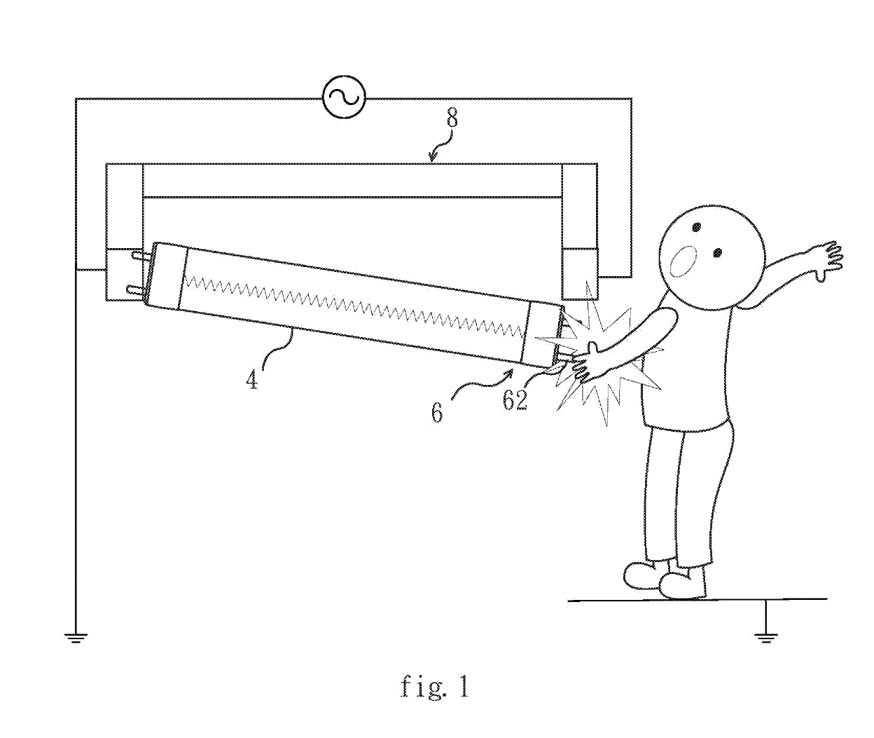

### DETAILED DESCRIPTION OF THE INVENTION

The techniques employed by the present invention to achieve the foregoing objectives, characteristics and effects thereof are described hereinafter by way of examples with reference to the accompanying drawings.

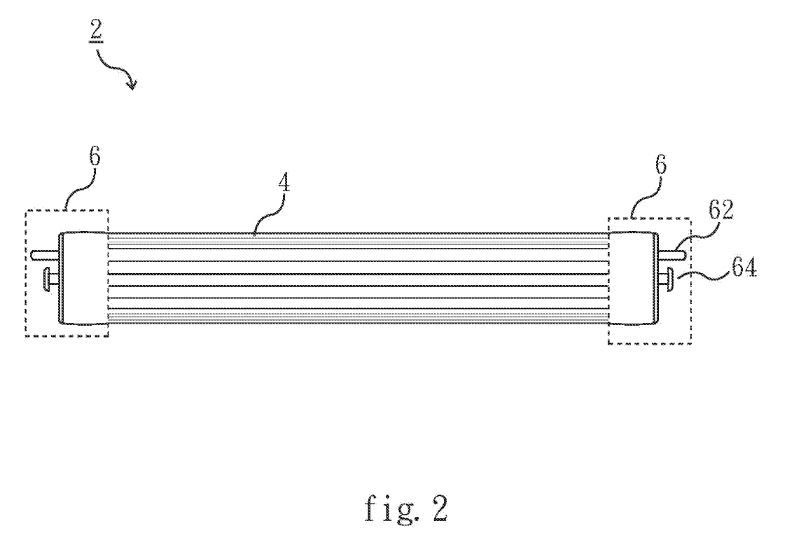

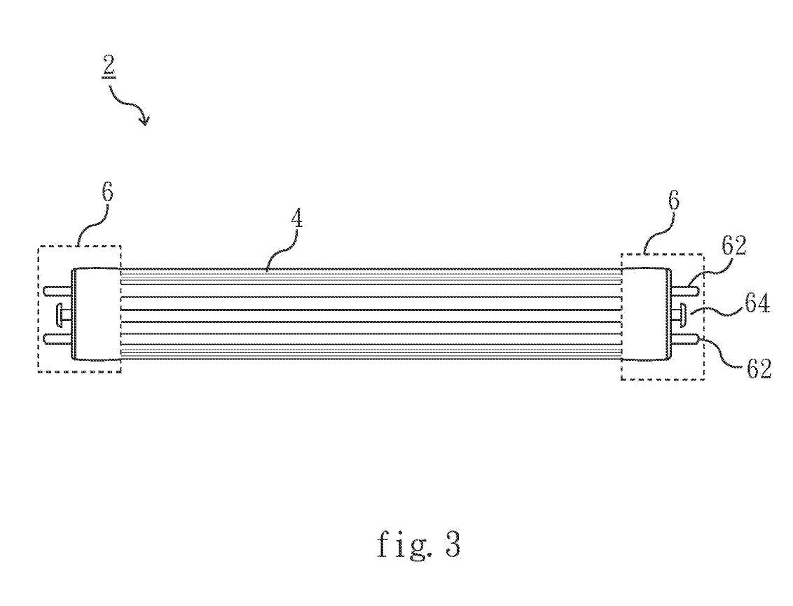

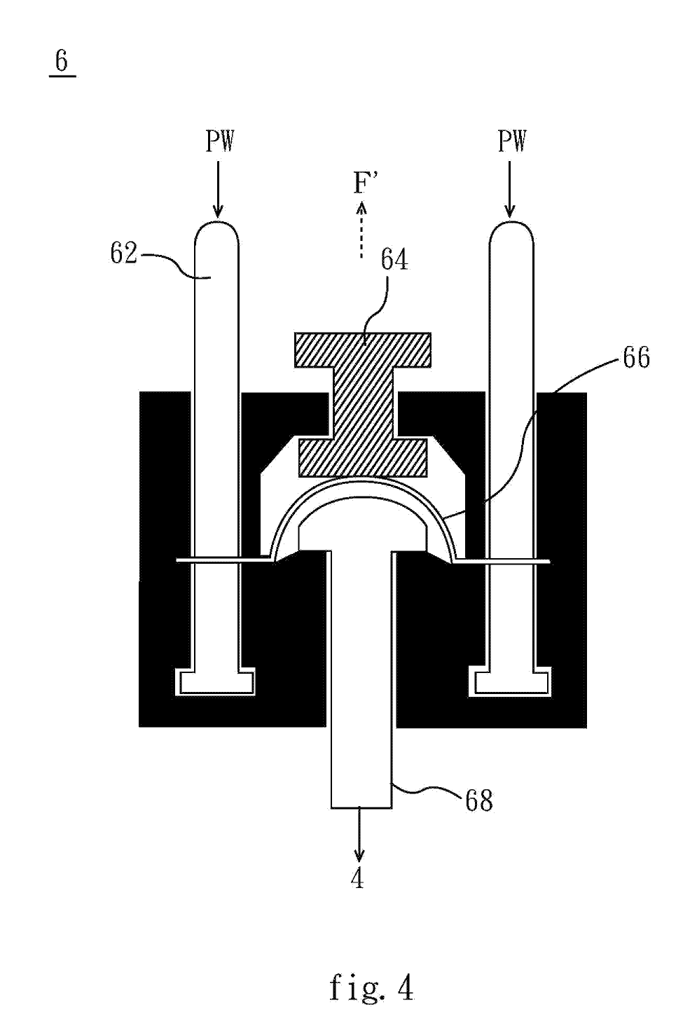

Referring to FIG. 2 and FIG. 3, FIG. 2 is a schematic view of an embodiment of a safety lamp of the present invention, and FIG. 3 is a schematic view of another embodiment of a safety lamp of the present invention. In the figures, the safety lamp 2 comprises a lamp body 4 and two electric connecting portions 6. The lamp body 4 has a light emitting module, and the light emitting module can be an organic light emitting diode (OLED) module, a light emitting diode (LED) module, or an electroluminescent (EL) module. Each of the two electric connecting portions 6 is respectively disposed on two sides of the lamp body 4, and each has a first electric connecting terminal 62 and a pressing switch unit 64 at its outside. It should be noted that the first electric connecting terminal 62 can have one electrode pin (FIG. 2) or more electrode pins, preferably two electrode pins (FIG. 3). Furthermore, referring to FIG. 4, which shows structure and operation of the electric connecting portion in FIG. 3. In FIG. 4, the electric connecting portions 6 further comprises a first electric connecting terminal 62, a pressing switch unit 64, an elastic conductive unit 66 and a second electric connecting terminal 68.

The first electric connecting terminal 62 is partly disposed in the electric connecting portion 6, and partly protruding from the electric connecting portion 6, and the first electric connecting terminal 62 is electrically connected to outside power source PW.

The pressing switch unit 64 is partly disposed in the electric connecting portion 6 and partly protruding from the electric connecting portion 6. The pressing switch unit 64 can contact the elastic conductive unit 66 directly or indirectly. The pressing switch unit 64 can be formed with nonconductive materials. In an embodiment, the pressing switch unit 64 can be in any shape, such as T-shaped. Here, the pressing switch unit 64 is shown as, but not limited to, H-shaped.

The elastic conductive unit 66 is electrically connected to the first electric connecting terminal 62, and the elastic conductive unit 66 can be semi-circular shaped. The elastic conductive unit 66 can be formed with copper sheet, and the copper sheet can be elastic. Furthermore, the pressing switch unit 64 can be closely disposed at one side of the elastic conductive unit 66.

The second electric connecting terminal 68 is electrically connected to the light emitting module, and by the electrical connection between the elastic conductive unit 66 and the second electric connecting terminal 68, the light emitting module can be electrically connected to the first electric connecting terminal 62. Furthermore, the second electric connecting terminal 68, relative to the pressing switch unit 64, can be distantly disposed at the other side of the elastic conductive unit 66.

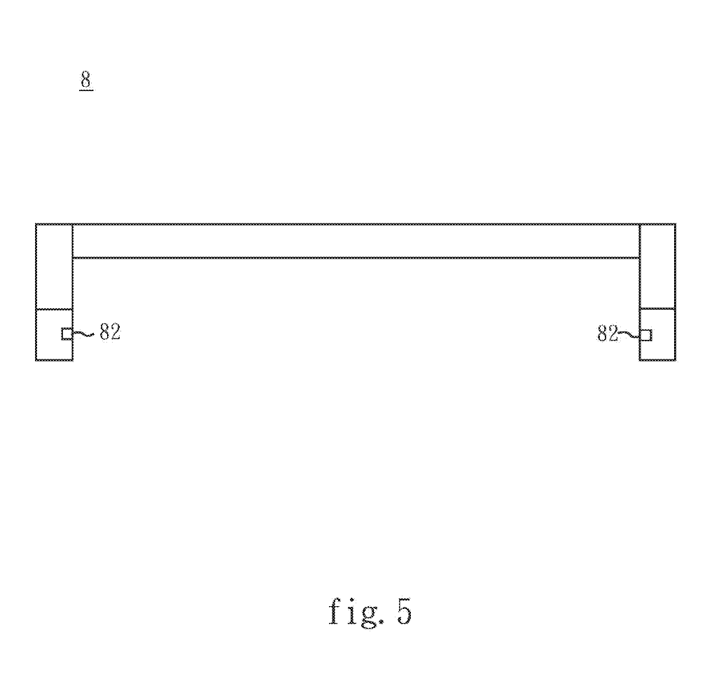

Furthermore, the safety lamp 2 is suited to be installed to a lamp holder 8. The lamp holder 8 has a plurality of slots 82 corresponding to the first electric connecting terminals 62 of the safety lamp 2, and the slots 82 are used to provide power source PW, as shown in FIG. 5. In other words, the slots 82 are used to fit with the first electric connecting terminals 62.

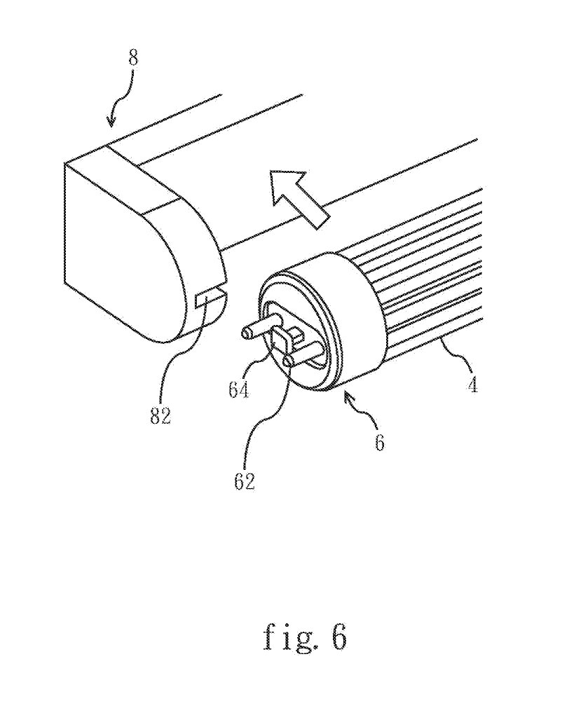

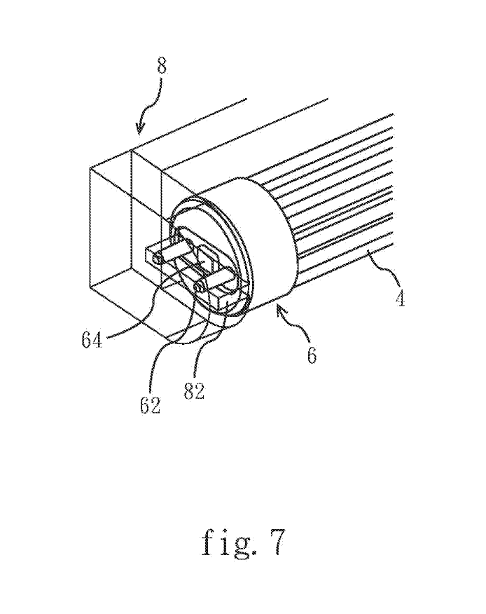

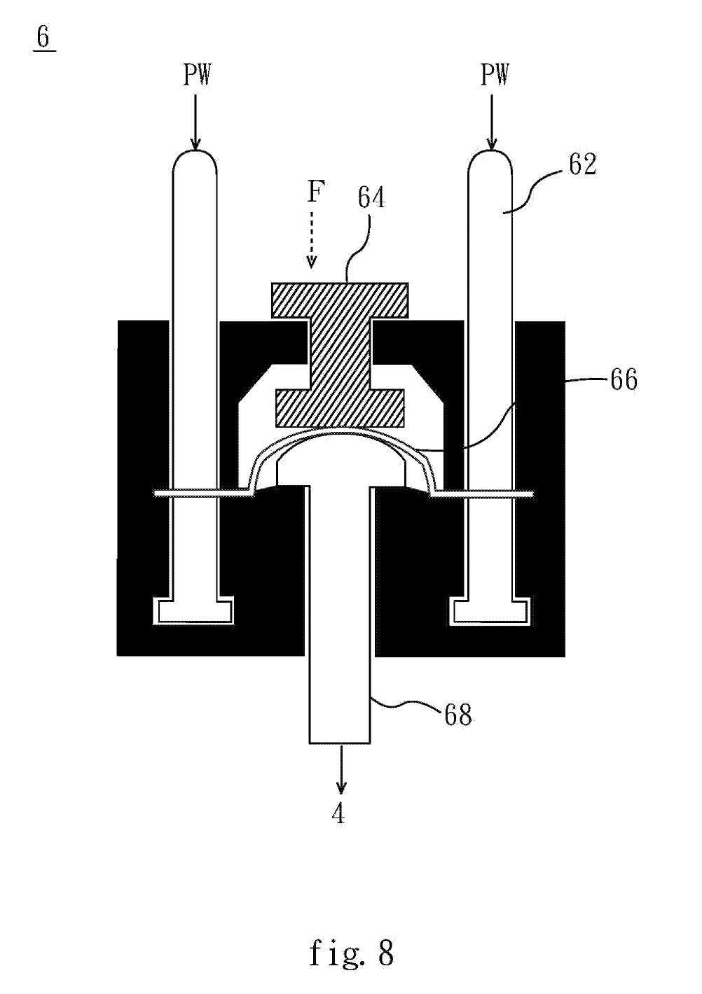

Referring to FIG. 6 and FIG. 7, when the safety lamp 2 is installed to the lamp holder 8, the pressing switch unit 64 sustains a pressing force F and urges against the elastic conductive unit 66 to deform (the elastic conductive unit 66 before deformation is shown in FIG. 4, and the deformed elastic conductive unit 66 is shown in FIG. 8), and the first electric connecting terminal 62 is electrically connected to the second electric connecting terminal 68 by the elastic conductive unit 66, and the second electric connecting terminal 68 is electrically connected to the lamp body of the safety lamp 2. It should be noted that, only when both of the two electric connecting portions 6 fit in the slots 82 of the lamp holder 8 and the corresponding pressing switch units 64 contact the lamp holder 8 and sustain the pressing force F, the pressing switch units 64 urge the elastic conductive units 66 such that the elastic conductive units 66 are electrically connected to the corresponding second electric connecting terminals 68 to form a conductive status between the first electric connecting terminals 62 and the second electric connecting terminals 68. Alternatively, when any of the pressing switch units 64 is released from the pressing force F, the deformed elastic conductive unit 66 reforms back to an opposite direction of the pressing force F and the resilience force F′ pushes the pressing switch unit 64 back to form an open circuit.

Therefore, in the process of installing the safety lamp 2 to the lamp holder 8, when one of the first electric connecting terminals 62 on one side of the safety lamp 2 fits in the slots 82 of the lamp holder 8, and the pressing switch unit 64 on the same side sustains the pressing force F and urges against the elastic conductive unit 66 to conduct the first electric connecting terminal 62 and the second electric connecting terminal 68, the first electric connecting terminal 62 on the other side of the lamp is not electrically connected to the corresponding second electric connecting terminal 68. Thus, even if a part of the body (such as a hand) of the user touches the first electric connecting terminal 62, there is no danger of electric shock. When installment of one side of the safety lamp 2 is finished and the first electric connecting terminals 62 on the other side of the safety lamp 2 fits in the slots 82 of the lamp holder 8 is to be performed, the gap between the slots 82 and the first electric connecting terminals 62 is too small for the body (such as the hand) of the user to fit in, and there is no danger of electric shock for the user. Comparing to the conventional technology, the safety lamp of the present invention is provided to be electrically connected via the elastic conductive unit by the control of the pressing switch unit. When the safety lamp is installed to or removed from the lamp holder, both pressing switch units of the two electric connecting portions on the two side of the safety lamp must be installed and pressed in the lamp holder to form a closed circuit between the safety lamp and the lamp holder. Thus, it is possible for the user to avoid being exposed to the electric shock in installing the lamp to the lamp holder, and high safety of lamp installment is achieved.

The preferred embodiments of the present invention have been disclosed in the examples. However, the examples should not be construed as a limitation on the actual applicable scope of the invention, and as such, all modifications and alterations without departing from the spirits of the invention and appended claims shall remain within the protected scope and claims of the invention.

What is claimed is:

1. A safety lamp suited to be installed to a lamp holder, the safety lamp comprising:
a lamp body having a light emitting module; and
two electric connecting portions respectively disposed on two sides of the lamp body, each of the electric connecting portions further comprising:
a first electric connecting terminal partly disposed in the electric connecting portion and partly protruding from the electric connecting portion for being electrically connected to a power slot of the lamp holder;
a pressing switch unit partly disposed in the electric connecting portion and partly protruding from the electric connecting portion;
an elastic conductive unit electrically connected to the first electric connecting terminal; and
a second electric connecting terminal electrically connected to the light emitting module;
wherein, when the pressing switch unit of each of the two electric connecting portions is free from pressing, the corresponding elastic conductive unit is not electrically connected to the corresponding second electric connecting terminal to form an open circuit between the first electric connecting terminal and the second electric connecting terminal; and
when each of the two electric connecting portions is installed to the lamp holder and the corresponding pressing switch unit is in contact to the lamp holder to sustain a pressing force, the pressing switch unit urges against the corresponding elastic conductive unit to electrically connect the elastic conductive unit to the corresponding second electric connecting terminal and to form a conductive status between the first electric connecting terminal and the second electric connecting terminal.

2. The safety lamp as claimed in claim 1, wherein the light emitting module is an organic light emitting diode module, a light emitting diode module, or an electroluminescent module.

3. The safety lamp as claimed in claim 1, wherein the first electric connecting terminal has two electrode pins.

4. The safety lamp as claimed in claim 1, wherein the elastic conductive unit is semi-circular shaped.

5. The safety lamp as claimed in claim 4, wherein the elastic conductive unit is formed with elastic copper sheet.

6. The safety lamp as claimed in claim 4, wherein the pressing switch unit is closely disposed at one side of the elastic conductive unit, and the second electric connecting terminal, relative to the pressing switch unit, is distantly disposed at the other side of the elastic conductive unit.

7. The safety lamp as claimed in claim 1, wherein the pressing switch unit is H-shaped.
